(19) United States
(12) Patent Application Publication
(10) Pub. No.: US 2003/0220920 A1
(43) Pub. Date: Nov. 27, 2003

(54) Matching database fields in an electronic design automation environment

(75) Inventors: Daniel S. Lake, Portland, OR (US); William Matthew Hogan, Lake Oswego, OR (US)

Correspondence Address: KLARQUIST SPARKMAN, LLP, 121 SW SALMON STREET, SUITE 1600, PORTLAND, OR, 97204, US

(73) Assignee: Mentor Graphics Corporation

(21) Appl. No.: 10/440,346

(22) Filed: May 15, 2003

Related U.S. Application Data
(60) Provisional application No. 60/383,456, filed on May 24, 2002.

(51) Int. Cl. G06F 7/00; G06F 17/30

(52) U.S. Cl. 707/6

(57) ABSTRACT

Methods and apparatus for matching database entries in an electronic design automation environment is disclosed. The disclosed technology may be applied, for instance, to import data (e.g., attributes or rules) from an EDA design database to an altered version of the EDA design database or to import data from a master database to an EDA design database. In one aspect, a match made between a first database entry and a second database entry is verified by comparing the second database entry to multiple entries of the first database, thereby helping to ensure that the first database entry is the best match for the second database entry. The matching may be performed using a similarity-based matching method. In another aspect, multiple criteria are used to determine whether a match exists between database entries and whether certain data should be imported between the databases.

### CROSS REFERENCE TO RELATED APPLICATIONS

This application claims the benefit of U.S. Provisional Patent Application 60/383,456, filed May 24, 2002, which is incorporated herein by reference.

### FIELD

The present disclosure concerns the management of databases. Specifically, it concerns the matching of databases used in electronic design automation.

### BACKGROUND

Databases are used extensively in computer-related applications to store and organize data. Typically, an entry (or “record”) of a database is divided into multiple fields, each containing a different type, or category, of data. For instance, a database used in a personal digital assistant (“PDA”) may store information concerning a user's business associates, friends, and family. Each entry of this database may contain separate fields for storing a person's name, address, phone number, etc.

Often, multiple copies of the database exist but are stored on different platforms. If one of the databases is partially updated, it is often desirable to update the other database without reentering information. For instance, a business owner may store extensive information regarding his clients on a work computer, but store a smaller amount of client information on his PDA. The business owner may occasionally update one or more fields of the database stored on the PDA, but not on the work computer. The business owner may then want to coordinate, or synchronize, the two databases so that the extensive database on the work computer is updated to contain the new information entered into the PDA without having to reenter any data.

Existing database management methods, however, are often incapable of accurately analyzing database entries such that data from an original database is effectively coordinated with data from a revised database. Many database management systems transfer data only if the value in a “key field” of the original database can be matched to a value in a corresponding key field of the updated database. The key field contains a fixed, unique identifier (often termed a “primary key”) for the respective database entry that cannot be repeated, altered, or duplicated. In the context of the PDA example, for instance, the primary key may connected with the name of a client such that a new primary key is created upon any alteration of the client's name. Thus, if the client's name is updated in the PDA, the database management system will not recognize that the updated entry of the PDA should be matched with the corresponding entry in the extensive client database. Therefore, the extensive client database will not be updated with any new information.

One context where the use of primary keys as a basis for coordinating databases is problematic is in the field of electronic design automation (“EDA”), where computer-aided software tools are used to design, route, simulate, and verify circuit designs (“EDA designs”). In a typical design flow in the EDA environment, design tools are used to create the logical layout of components in a circuit (e.g., printed circuit boards, optical circuits, etc.). The design tools may also be used to route the components of the design (e.g., the parts of a printed circuit board). The EDA design may be represented as a multi-field database that includes all the necessary data defining the design.

Once an EDA design has been created, simulation tools may be used to simulate the performance of the circuit while taking into account real-world constraints (e.g., physical constraints, electrical constraints, etc.). To perform the simulation, the EDA database from the design environment is loaded into the simulation environment. The relevant constraints, termed “rules,” and other design attributes are then inserted into additional fields of the EDA database. These additional fields are typically available only in the simulation environment. Once the attributes and/or rules are inserted or entered into the appropriate fields—a process which can often be time-consuming on account of the large number of components and nets present in an EDA design—the design is simulated. Simulating the EDA design while taking into account electrical and other physical constraints allows a designer to detect areas in the design that do not perform as expected. Whenever a design flaw is detected, the designer can reload the EDA database into the design environment, where the additional fields are not supported, and correct the problem by updating the design. This process of testing the performance of a design using simulation tools allows circuit designers and manufacturers to place their products on the market more quickly and less expensively than previously possible.

As noted, the EDA design is typically altered whenever a design flaw is detected by the simulation tools. By altering the design, however, a designer usually alters the entries of the EDA database. When the revised EDA design is reloaded into the simulation environment for testing, the revised entries may not be recognized by the simulation tools. For instance, the simulation tools may match entries from the original EDA design database to the revised EDA design database through the use of primary keys. Thus, if one of the altered fields is associated with the primary key, the revised database entry will not be matched with the proper original database entry, thereby requiring a designer to reinput the attributes and/or rules. If significant design changes occur, the amount of data lost may be substantial, and the time required to reinput the data considerable.

Accordingly, it is desirable for a database management method or apparatus to accurately coordinate databases without relying on primary keys. Instead, the database management method or apparatus should have sufficient flexibility to account for various types of changes that might be made to the EDA design database. Moreover, the database management method or apparatus should be configurable so that a user can fix criteria establishing when and how much design data should be transferred. Finally, on account of the large amount of data that may be contained in a database, the database management method or apparatus should be efficient and use as few memory and processing resources as possible.

### SUMMARY

The present disclosure describes methods and apparatus for matching database entries in an electronic design automation (“EDA”) environment. The disclosed technology does not depend exclusively on data contained in “key fields,” but instead uses data contained in non-primary-key fields of the database entries. The disclosed technology can provide enhanced flexibility and can be used to match large numbers of database entries, such as those that are often present in EDA designs. In one embodiment, rules and/or attributes are updated from an EDA design database to an altered version of the EDA design database. The altered version of the EDA design database may be a revised EDA database, such as one that is created when an EDA design is altered after computer simulation reveals design defects. In another embodiment, rules and/or attributes are imported from a master database containing known rules and attributes to a new EDA design database. These particular uses are not limiting, however, and the disclosed technology may be used to match any type of database with another database.

According to one aspect of an embodiment, a selected entry from a first database is compared to multiple entries from a second database. The selected entry is matched to one of the multiple entries from the second database. The matching is verified by comparing the matching entry from the second database with multiple entries from the first database and determining whether the matching entry matches with the selected entry. In this embodiment, the verifying is performed before comparing and matching a next entry. The matching entry is verified in order to ensure that the match is the best possible match for the selected entry and to allow the method to make an effective match in a single iteration. If the match is verified, selected fields of the database entries may be transferred. For instance, certain fields of the selected entry in the first database may be imported to corresponding fields of the matching entry in the second database. Alternatively, selected fields of the matching entry in the second database may be imported to corresponding fields in the first database. The imported fields may contain, for instance, attributes and/or rules that apply to the EDA design.

In another aspect of an embodiment, the matching and verifying are performed according to one or more predetermined criteria. In one implementation, the selected entry of the first database is matched with a matching entry of the second database if data in one or more non-primary-key fields of the selected entry is identical to data in a corresponding field or fields in the matching entry. In another implementation, the selected entry of the first database is matched with a matching entry of the second database if data in one or more fields of the selected entry is similar to data in a corresponding field or fields in the matching entry. The entries may be similar if, for instance, a field of the selected entry has a portion of data present in the corresponding field of the matching entry and a remaining portion of data not present in the corresponding field of any entry of the second database. A similarity-based matching method may also be used during the verification process. By using a similarity-based matching method for both matching and verifying, the method can determine whether data deleted from a matching entry is completely removed from the second database, whether data added to the matching entry is completely new to the second database, or whether data has been moved from other entries. In the EDA context, this type of method may be used to determine whether components in a design have been added, deleted, or merely relocated during a design revision.

In another aspect of an embodiment, multiple criteria can be used to match the database entries. For instance, a first database entry may be matched to a second database entry by determining whether selected fields of the first database entry meet a first criteria or a second criteria when compared to corresponding fields of the entries of the second database. The match may also be verified using multiple criteria. In another aspect of an embodiment, the fields of data that are imported after a database entry is matched with another database entry depend on what criteria were satisfied. For instance, a first set of data may be imported if the first criteria is satisfied, and a second set of data may be imported if the second criteria is satisfied.

Further features and advantages of the disclosed technology will become apparent with reference to the following detailed description and accompanying drawings.

### BRIEF DESCRIPTION OF THE DRAWINGS

FIG. 1 is a block diagram illustrating various conventions that are used to describe an EDA design, such as a PCB design.

FIG. 2 is a block diagram further illustrating various conventions that are used to describe an EDA design.

FIG. 3 is a block diagram illustrating the use of multi-dimensional databases to describe an electrical net as may be used in an EDA design.

FIG. 4 is an exemplary EDA design database.

FIG. 5A is a flowchart for matching database entries and importing selected data according to a first representative embodiment.

FIG. 5B is a flowchart of an alternative implementation for matching database entries and importing selected data.

FIG. 6 is a block diagram illustrating a similarity-based matching method as may be used in the methods illustrated in FIG. 5A or FIG. 5B.

FIG. 7 is a block diagram illustrating a second representative embodiment.

FIG. 8 is a first illustration of the second representative embodiment.

FIG. 9 is a second illustration of the second representative embodiment.

FIG. 10 is a third illustration of the second representative embodiment.

FIG. 11 is a fourth illustration of the second representative embodiment.

FIG. 12 is a fifth illustration of the second representative embodiment.

FIG. 13 is a sixth illustration of the second representative embodiment.

FIG. 14 is a seventh illustration of the second representative embodiment.

FIG. 15 is a block diagram illustrating a third representative embodiment.

FIG. 16 is a first illustration of the third representative embodiment.

FIG. 17 is a second illustration of the third representative embodiment.

FIG. 18 is a third illustration of the third representative embodiment.

FIG. 19 is a fourth illustration of the third representative embodiment.

FIG. 20 is a fifth illustration of the third representative embodiment.

FIG. 21 is a sixth illustration of the third representative embodiment.

FIG. 22 is a seventh illustration of the third representative embodiment.

FIG. 23 is a system diagram of a client/server network for implementing the disclosed database matching procedures.

FIG. 24 is a flowchart showing the creation of a database using the network of FIG. 23.

### DETAILED DESCRIPTION

Methods and apparatus for matching database fields in an electronic design automation (“EDA”) environment are shown and described herein. The methods described herein can be implemented in software stored on a computer-readable medium and executed on a computer. The disclosed technology, for example, can be implemented in computer-aided design and simulation tools. Further, the disclosed technology may be executed on a single computer or on a networked computer. For clarity, only those aspects of the software germane to the disclosed technology are described; product details well known in the art are omitted. For the same reason, the computer hardware is not described in further detail. It should thus be understood that the disclosed technology is not limited to any specific computer language, program, or computer. The methods can also be implemented by specifically designed hardware dedicated to performing the described procedures or by other apparatus or systems.

The disclosed technology is described below in connection with representative embodiments that are not intended to be limiting in any way. Although the specific embodiments are discussed as relating to an EDA design, the methods and apparatus described can be applied to any situation involving a first database to be matched to a second database.

General Considerations

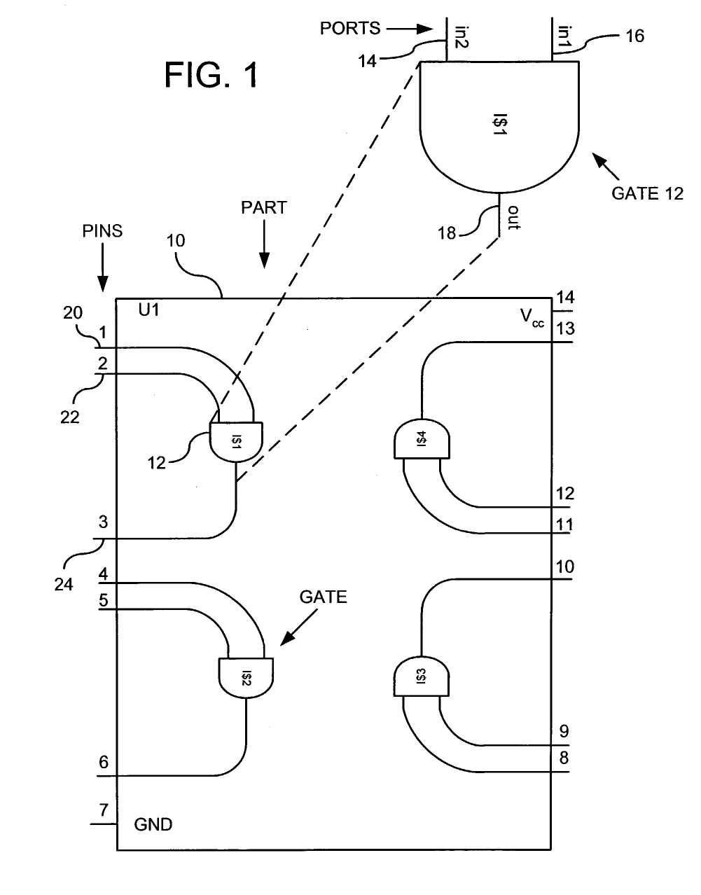

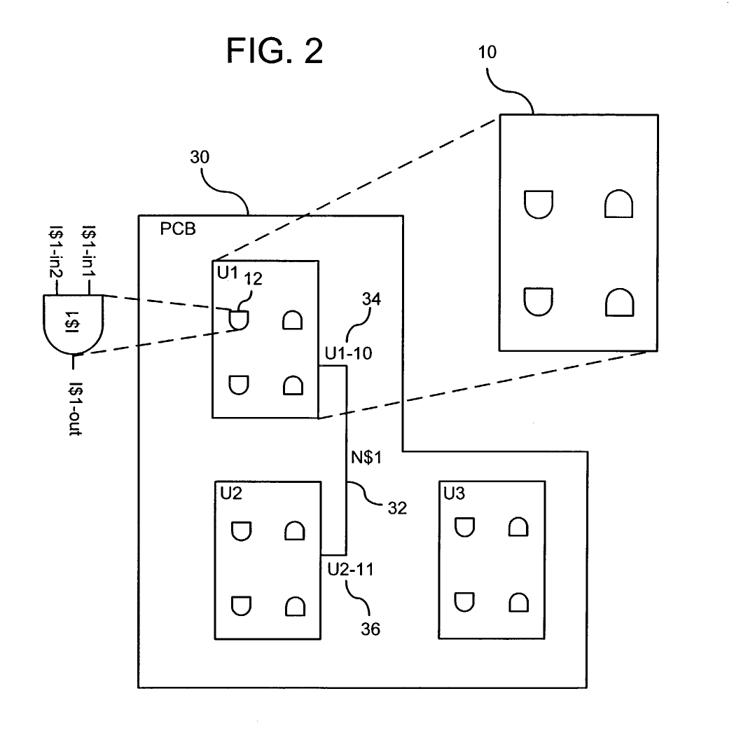

FIGS. 1 and 2 show exemplary components (or “design data objects”) of an EDA design and illustrate the convention used throughout the present disclosure to refer to such components. For illustrative purposes only, the EDA design is a printed circuit board (“PCB”). The EDA design, however, may be any circuit design (e.g., an optical circuit). The components shown and the convention described herein are not to be construed as limiting in any way, but can vary without departing from the disclosed principles.

FIG. 1 shows a part 10 of a PCB. The part 10 may be, for instance, an integrated circuit comprising various digital or analog components. The part 10 has a part name (e.g., 74AC08) that may be standardized so that a designer can determine the operation of the part from its part name. The various components of the part 10 may include, for instance, gates (e.g., AND, NAND, OR, NOR, XOR), memory units (e.g., latches, flip-flops, registers), resistors, inductors, capacitors, and other components known in the art. In FIG. 1, for example, part 10 comprises four AND gates, including gate 12. Each instantiation of a gate on a board may be referred to by a “gate instance” reference. For instance, for the part shown in FIG. 1, the gates may be referred to as “I$1” through “I$4.” Each gate on a part may have multiple ports used to input or output a signal. For instance, in FIG. 1, gate 12 has three ports—two input ports 14, 16 and an output port 18. The ports 14, 16, 18 may further be referenced by their port type. For instance, port 16 of gate 12 may be “in1,” port 14 “in2,” and port 18 “out.” The gate instance reference and the port type reference may be combined into a single reference, termed a “port instance,” that provides a more complete description of a particular port on a board. For instance, in FIG. 1, port 16 may be referred to as “I$1-in1,” port 14 as “I$1-in2,” and port 18 as “I$1-out.”

Part 10 further comprises multiple pins that provide access to the components of the part. For instance, in FIG. 1, part 10 comprises fourteen pins: twelve pins accessing the four AND gates, one pin grounding the part, and one pin for providing a supply voltage to the part. In FIG. 1, each pin is designated by a corresponding numeral “1” to “14.” Similar to the gates within a part, each instantiation of a part on a board may be referred to by a part instance reference. For example, part 10 shown in FIG. 1 may be designated as “U1.” The part instance reference and the pin number may be combined into a single reference, termed a “pin instance,” that provides a more complete description of a particular pin on a board. For instance, in FIG. 1, pins 1-3 of part 10 may be referenced as “U1-1,” “U1-2,” and “U1-3,” respectively.

FIG. 2 shows a PCB 30 that includes three parts, including part 10. The three parts also include part instance references—namely, “U1,” “U2,” and “U3.” Gate 12, with its three port instances—“I$1-in1,” “I$2-in2,” and “I$1-out”—are also shown. FIG. 2 further includes two pin instances 34, 36. Pin instance 34 is referenced as “U1-10” and corresponds to the tenth pin on the U1 part instance (i.e., part 10). Similarly, pin instance 36 is referenced as “U2-11” and corresponds to the eleventh pin on the U2 part instance. An electrical net 32 connects pin instance 34 to pin instance 36. In general, an electrical net corresponds to the complete electrical connection created between pins of the parts on the PCB. In FIG. 2, electrical net 32 is referenced as “N$1.” An electrical net may include other electrical components (e.g., a resistor) that divide the electrical net into smaller divisions termed “physical nets.” A physical net may be referenced by a separate net name or may share the name of its related electrical net.

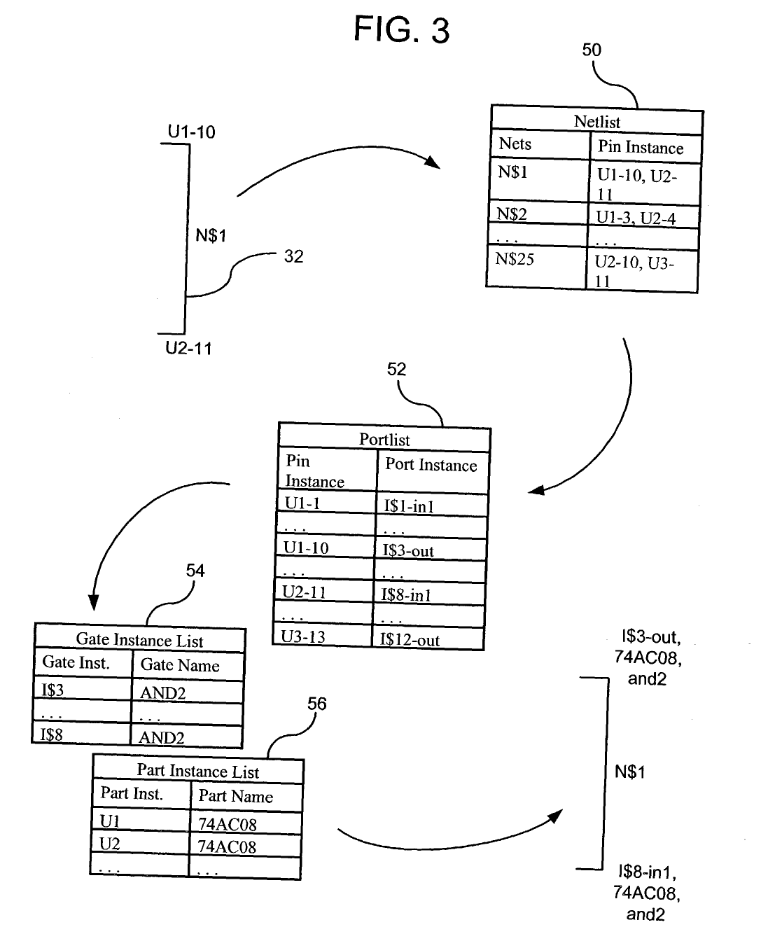

FIG. 3 shows an example of how the various references may be compiled and related to each other in multiple databases. As shown in FIG. 3, a “netlist” may be compiled that relates the various nets to their corresponding pin instances. For example, netlist 50 shows that electrical net 32 (i.e., “N$1”) comprises the electrical net between pin instances “U1-10” and “U2-11.” A “portlist” may also be compiled that relates pin instances to port instances. The portlist may thus be used to describe any electrical net in terms of the corresponding port instances. In the example shown in FIG. 3, for instance, a portlist 52 and netlist 50 indicate that net 32 (“N$1”) is the electrical net between port instances “I$3-out” and “I$8-in1.” Other databases may also be compiled containing various other information about the components and layout of the PCB. For instance, a gate instance list may be compiled that relates gate instances to gate names. Similarly, a part instance list may be compiled that relates part instances to part names. Thus, a variety of information can be used to describe the electrical nets of a PCB. For instance, as shown in FIG. 3, gate instance list 54 and part instance list 56 may be used to describe net 32 (“N$1”) as originating at port instance “I$3-out,” which is the output of an AND2 gate on a 74AC08 part, and terminating at port instance “I$8-in1,” which is the first input of an AND2 gate on a 74AC08 part. Thus, it is possible to compile multiple databases containing various information regarding the PCB design. The multiple databases may be accessed and their information imported according to the specific needs of the designer or database management tool. In this manner, the databases are multi-dimensional.

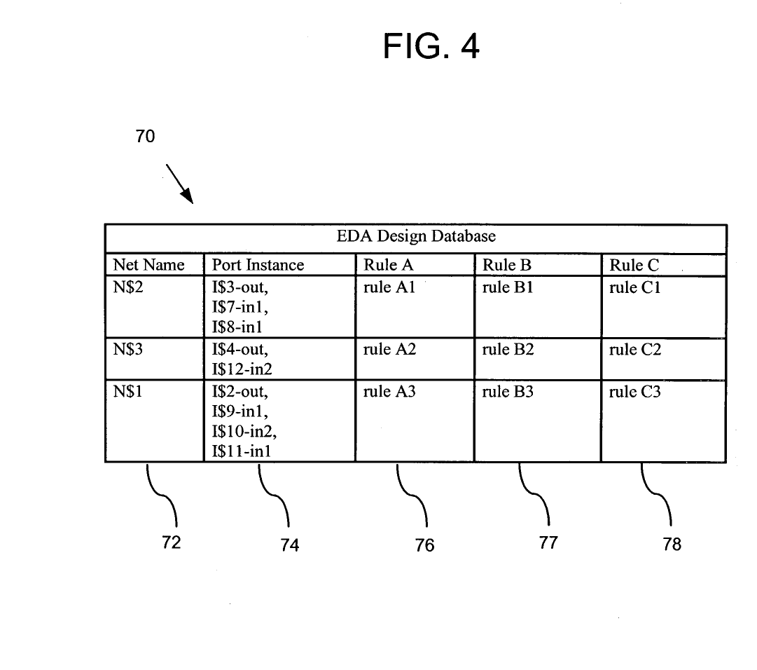

The various electrical connections of an EDA design, such as a PCB design, may also have associated with them a number of attributes or rules used by the EDA software. The rules may include model assignments, physical net properties, physical net rules, electrical net properties, electrical net rules, pin instance pair rules, pin instance properties, electrical net class rules, and electrical net class assignments. FIG. 4 shows an exemplary EDA design database 70 that may be compiled and used to describe a particular circuit design in a simulation tool. Field 72 shows the net name of various entries of the database, field 74 shows the port instances associated with the various nets, and fields 76, 77, 78 show three representative fields containing rules associated with each entry. Although fields 76, 77, 78 are shown as containing rules, the fields may also contain attributes associated with the particular entry. The attributes or rules may be, for instance, attributes or rules used for: (1) checking the signal integrity on the nets of the design (e.g., a crosstalk limit, an overshoot limit, an undershoot limit, a ringback high margin, a ringback low margin, a monotonicity required, an impedance target); (2) checking the timing requirement on the nets (e.g., an allowed minimum delay, an allowed maximum delay, a timing path visibility, a constrained edge); (3) giving information about the topology of the net (e.g., a topology type, a short line ratio, information about branch heads, a maximum stub rise time factor, a maximum load terminator rise time factor, a maximum source series resistor rise time factor); (4) giving information regarding differential pairs on physical nets (e.g., physical net names, differential pair net names, routing styles, a spacing override); (5) giving information regarding the material of the EDA design (e.g., material name, material type, dielectric constant, loss tangent, resistivity); and/or (6) giving information regarding the current cross-section of the EDA design (e.g., layer name, layer type, dielectric type, conductor type, thickness, reference plane, power nets, routing preference). These examples, however, are not limiting in any way and other types of attributes or rules are possible. For example, the port instance and part instance references described above may be included among the attributes of an EDA design database entry.

First Representative Embodiment

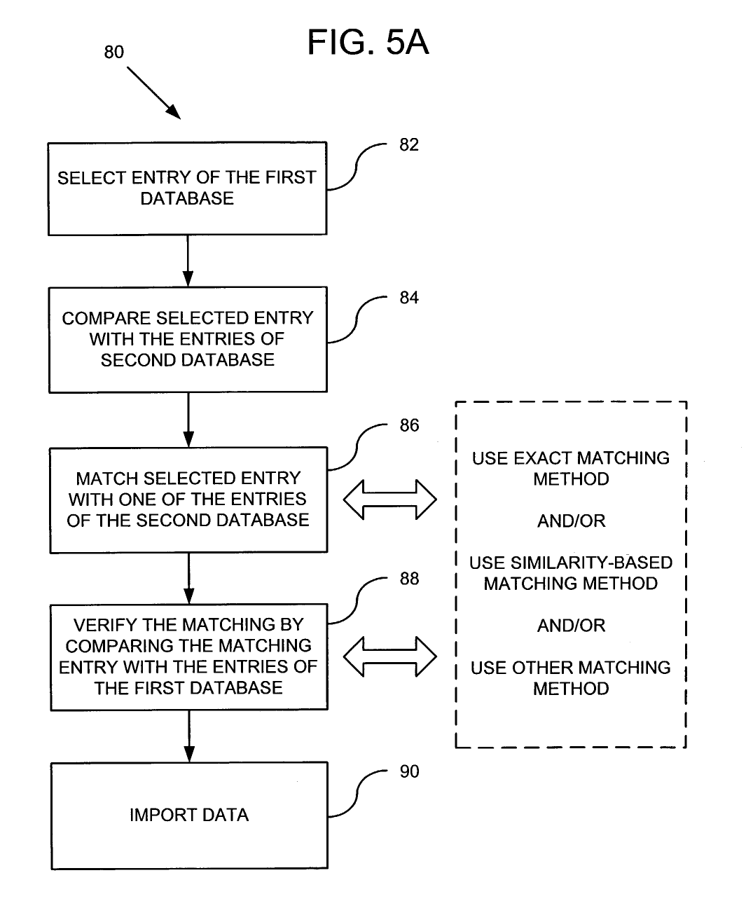

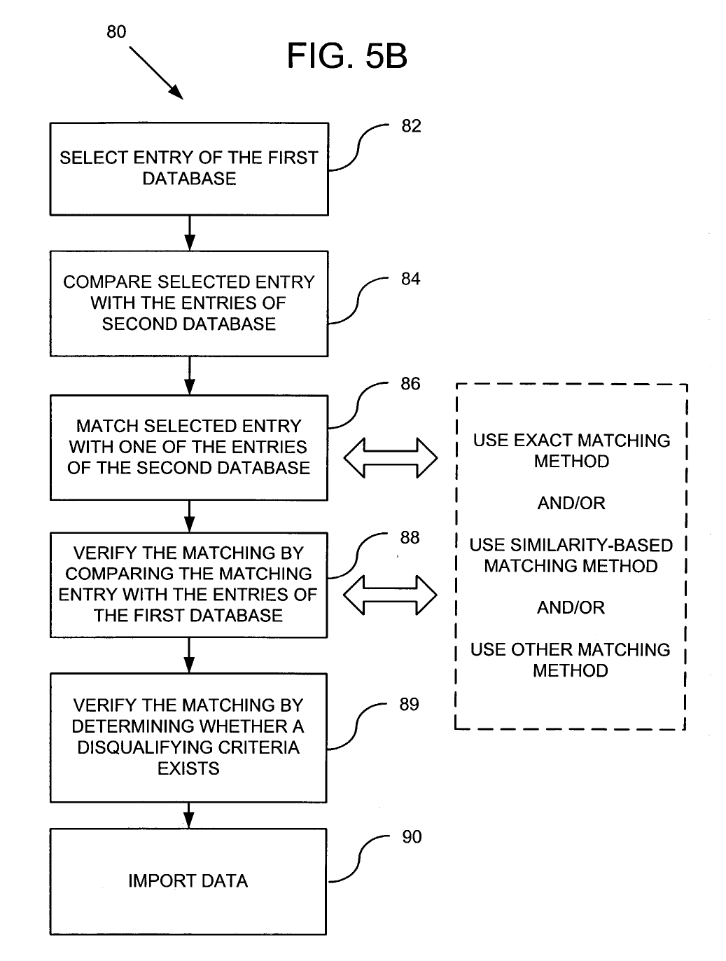

FIG. 5A is a flowchart showing one embodiment of a general method 80 of matching database entries as may be used by an EDA hardware or software tool. The general method 80 may, for instance, be applied to import rules and/or attributes from an EDA design database to an altered version of the EDA design database (discussed below with respect to the second representative embodiment). Alternatively, the method may be used to match other types of databases.

At process block 82, an entry from the first database is selected. The entry may be selected based on a number of different criteria or methodologies. For instance, the selection may be based on the name of the first field, on some numerical component of the field, on the time of entry or update, on the location of the entry in the database, or randomly.

In process block 84, the selected entry of the first database is compared with multiple entries of the second database. In this process, one or more selected fields of the selected entry may be compared with corresponding fields of the entries in the second database. In one implementation of the method, for instance, the selected entry is compared with all of the entries of the second database. In another implementation of the method, the selected entry is compared with only those entries of the second database that have not been matched with an entry from the first database.

In process block 86, the selected entry is matched with one of the entries of the second database. The matching may be performed based on a predetermined criteria. For instance, in one implementation, the criteria is whether certain fields of the selected entry contain data that is identical to data in corresponding fields in an entry of the second database. In this implementation, the fields that are used are not key fields but fields that contain editable data. A match according to this method is found only if the entry in the second database contains identical data in the selected fields. For instance, in a particular implementation in the EDA environment, an electrical net of an original design database is matched with an electrical net of a revised EDA design database only if the two nets have the same list of port instances and the two nets have the same physical net distribution. In another particular implementation, an electrical net of an EDA design database is matched with an electrical net of a revised EDA design database if the name of the two electrical nets is the same.

In another implementation, the criteria is whether certain fields of the selected entry contain data that is “similar” to corresponding fields in an entry of the second database. A variety of tests may be used to determine whether two entries are similar. For instance, the selected entry from the first database may be deemed similar to an entry of the second database if a portion of data from one or more selected fields of the selected entry is found in a single entry of the second database and if the remaining portion of data is not found in any entry of the second database. Further, at least one item of data in the selected field of the selected entry must be found in the corresponding field of an entry from the second database. This similarity-based matching method increases the flexibility of the general method illustrated in FIG. 5A by relaxing the requirement of an exact match. In the EDA context, the use of similarity-based matching recognizes that EDA design alterations may add or delete connections or components of the design without altering attributes and/or rules assigned to the underlying components or connections.

At process block 88, the matching performed at process block 86 is verified, or cross-checked, by comparing the matching entry of the second database with one or more entries of the first database. In one implementation, for example, the verification is performed by comparing the matching entry found in process block 86 with all entries of the first database. During the comparison, the matching entry may be matched with an entry of the first database using one of the matching methods described above with respect to process block 86. In one implementation, for instance, the same matching method from process block 86 is used in the verification process. Alternatively, a different matching method is used, or different fields are considered during the verification process.

If the verification process finds that a match is made with the same entry of the first database as the selected entry from process block 82, then the match is verified; otherwise, the match is rejected. The rejected match may be reported to the designer in a separate database containing a list of all unmatched entries. The process of verifying the match helps ensure that the best possible match for the selected entry is made using a single iteration of the general method. In other words, the verification process allows the method to operate effectively in a single pass.

By using a similarity-based matching method for both matching and verifying, the method can determine whether data deleted from a matching entry during a revision or update is completely removed from the second database, whether data added to the matching entry is completely new to the second database, or whether data has been moved from other entries. Thus, in the EDA context, this type of method may be used to determine whether components in an EDA design have been added, deleted, or merely relocated during a design change.

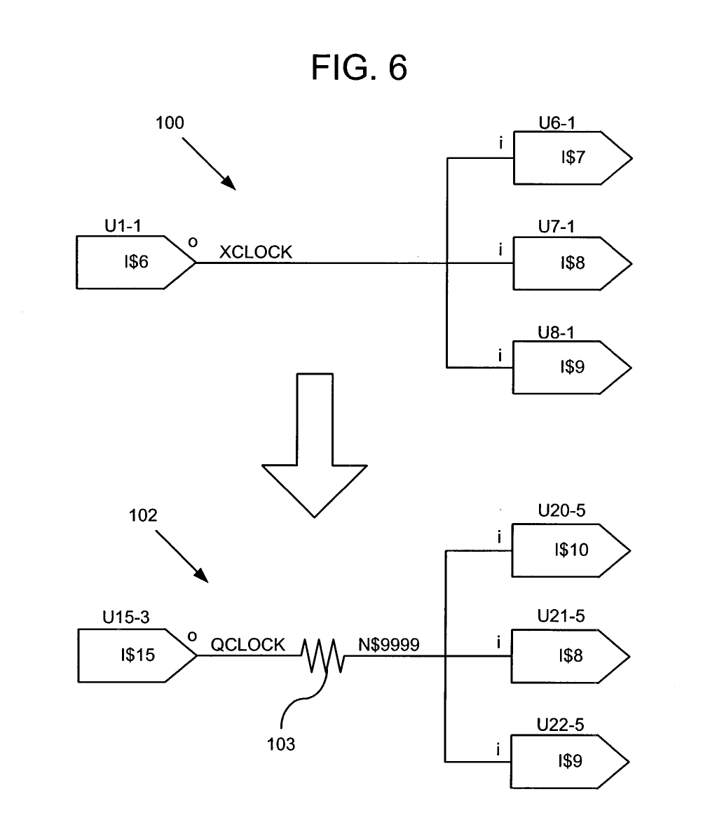

FIG. 6 illustrates an exemplary match and verification made using a similarity-based matching method in the EDA environment. Net 100 is an electrical net from an EDA design database. Net 102 is the same electrical net from a revised EDA design database. After the revision, the part and pin instances are renumbered, the electrical net is renamed, a resistor 103 is added to the electrical net (forming a physical net N$9999), the output that electrical net 100 was connected to (I$6) was removed and replaced by a new output (I$15) that did not previously exist in the design, and one of the outputs (I$7) to which net 120 was connected was removed and replaced with a new input (I$10) that did not previously exist in the design.

In the implementation illustrated by FIG. 6, the similarity-based matching method compares the port instance fields of the original EDA design database with the corresponding port instance fields of the revised EDA design database. For a match to be found, the exemplary matching method requires that, for each port instance of the original net 100, the port instance must be present in a single net 102 or else not present anywhere in the revised EDA design database. If a matching entry of the updated design database is found, then the match is verified by comparing the matching entry with all of the entries of the original design database. The exemplary verification method requires that, for each port instance of the updated net 102, the port instance must be present in the original net 100 or else not present anywhere in the original EDA design database. Thus, any removed port instances must be removed entirely from the design, and any new port instances must be completely new to the design. Accordingly, if an electrical net is split into multiple electrical nets or if multiple electrical nets are merged into one during the revision, no match would be found according to this method. In the example illustrated in FIG. 6, the nets 100, 102 are matched and verified because the removed output port instance (I$6) is removed from the design, the new output (I$15) is new to the design, the removed input port instance (I$7) is removed from the design, and the new input port instance (I$10) is new to the design.

Returning to FIG. 5A, at process block 90, if a match is found and verified in process blocks 86, 88, data from one of the databases is imported to the other database. For instance, in one implementation, data from predetermined fields of the selected entry in the first database is transferred to the corresponding fields of the matching entry of the second database. The data imported may replace existing data or be imported into blank fields of a database. The data transferred may vary depending on what fields of the databases are matched and/or the matching and verifying methods used. For instance, in the EDA environment, the data that is transferred may comprise attributes or rules used by the simulation tools. In one particular implementation, for example, if an electrical net of a first database is matched with an electrical net of a second database, rules used for checking signal integrity (e.g., noise rules), timing rules, topology rules, and cross-section attributes are imported from the first database to the second database.

FIG. 5B illustrates a different implementation of the method described above with respect to FIG. 5A. The implementation shown in FIG. 5B may be used to import rules and/or attributes from a master database of known rules and attributes to an EDA design database (discussed below with respect to the third representative embodiment). In general, the method 80 illustrated in FIG. 5B is identical to the method of FIG. 5A discussed above. As shown at process block 89, however, the verification process further includes determining whether a disqualifying attribute exists that may cause the match to be rejected. For instance, the matching entry of the second database may have a particular attribute (e.g., a part type or net type) that makes the entry unsuitable for matching with the selected entry. This attribute may appear as data in an additional field of the matching entry not considered in the initial matching at process block 86. Once the match is made, however, the additional data may be compared with a corresponding field in the selected entry or a separate database to ensure that the match can be made. For instance, a part type listed in the matching entry may no longer be available (as determined by a secondary database containing a list of all the available parts). Thus, when the verification process considers this additional attributes, the match between the selected entry and the matching entry will be rejected because of the disqualifying criteria. Further, the direction in which data is imported in process block 90 may be different for the method shown in FIG. 5B. In contrast to the implementation described above with respect to FIG. 5A, data from predetermined fields of the matching entry of the second database may be imported to the corresponding fields of the selected entry of the first database.

For any of the methods described herein, the matching methods used may be combined with other matching methods such that a particular implementation uses multiple matching methods to determine whether a match exists. For instance, in one embodiment, an exact matching method may be utilized first, followed by a similarity-based matching method, followed by a second exact matching method analyzing different fields. Further, the multiple matching methods can be ordered such that the strictest method is performed first, and subsequent methods are progressively less strict. The verification process can use an identical order of multiple matching methods so that stricter criteria are always checked before less strict criteria.

The number and type of fields that are transferred (i.e., imported) between databases may also depend on the matching methods used. Thus, a first set of data may be transferred if a first criteria is met, and a second set of data may be transferred if a second criteria is met. For example, both an exact matching method and a similarity-based matching method may be used to match an electrical net in a selected entry of a first database with an electrical net of a second database. If an exact match is found, a first set of attributes and/or rules may be transferred (e.g., topology rules), but if only a similarity-based match is found, a second set of attributes and/or rules may be transferred (e.g., no topology rules). The number of criteria that are tested and the particular fields of data transferred may vary depending on the particular application for which the method is used.

The general methods of FIGS. 5A and 5B may be applied over multiple iterations in order to fully update a database, each iteration using a different implementation of the methods directed at different fields of the databases. For instance, each iteration may utilize different matching methods and import different attributes and/or rules upon satisfaction of those matching methods. Moreover, each iteration of the general methods may analyze attributes that were imported through an earlier iteration.

Second Representative Embodiment

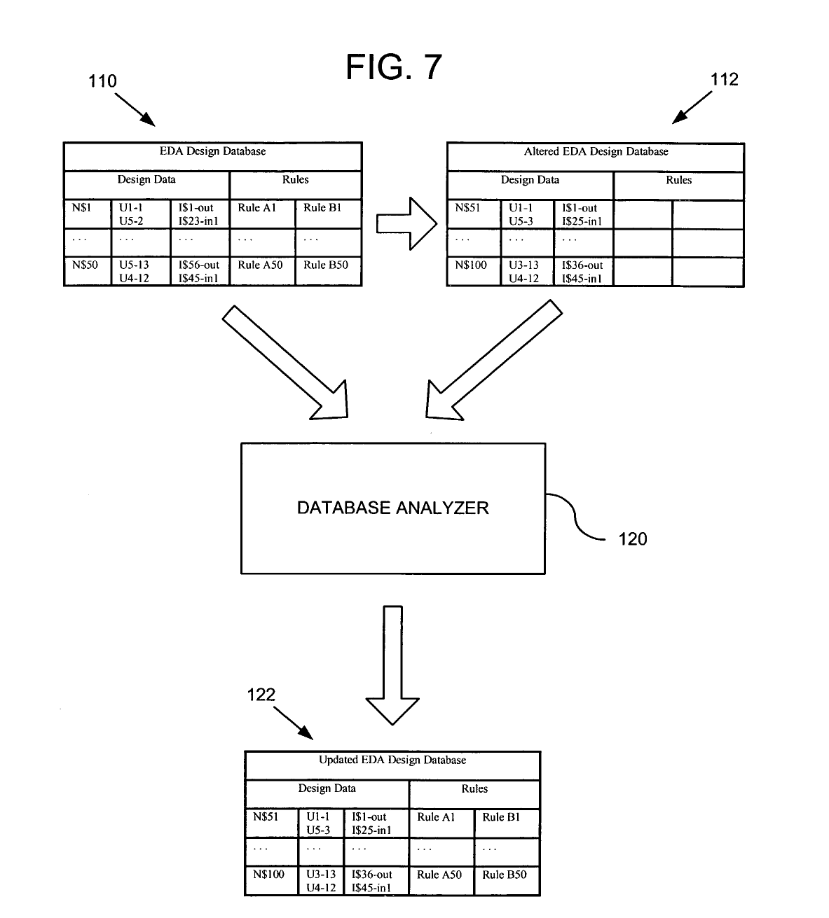

FIG. 7 is a block diagram illustrating the operation of a second representative embodiment. In general, the second representative embodiment involves importing attributes and/or rules from an EDA design database 110 to a revised EDA design database 112. The EDA design database 110 contains design and rules data for an exemplary EDA design. The EDA design database 110 may be originally compiled using design tools. The EDA design may then be tested by simulation tools, where the EDA design database is expanded to include a number of additional fields for various additional design attributes and/or rules. As discussed above, these attributes or rules may represent other design characteristics, electrical constraints, timing constraints. The EDA design database 110 may need to be modified to correct problems in the design detected during simulation. To correct the detected problems, the EDA design database may be reloaded into the design environment, where the additional fields for attributes and/or rules are not supported. During the update, alterations to various fields of the design database may be made. For instance, the design tools may alter an electrical net, part instance, or gate instance. Accordingly, when the revised EDA design database is reloaded into the simulation environment, certain attributes and/or rules originally associated with the various components of the EDA design may be lost because of the alterations. Accordingly, the revised EDA design database is analyzed by a database analyzer 120, which matches entries from the two databases according to the methods described above and which transfers the appropriate attributes and/or rules from the EDA design database to the revised EDA design database. Although the EDA design database 112 shown in FIG. 7 corresponds to a revised EDA design database, the database may be any altered version of the EDA design database (e.g., an earlier version). After analysis, the database analyzer 120 outputs an integrated EDA design database 122 that includes the transferred rules. Accordingly, a designer does not need to reenter the original rules into the revised EDA design database 112, a process that can be extremely time-consuming. Entries of the revised EDA database 112 that the data analyzer 120 is unable to match may be reported to a designer in a separate database.

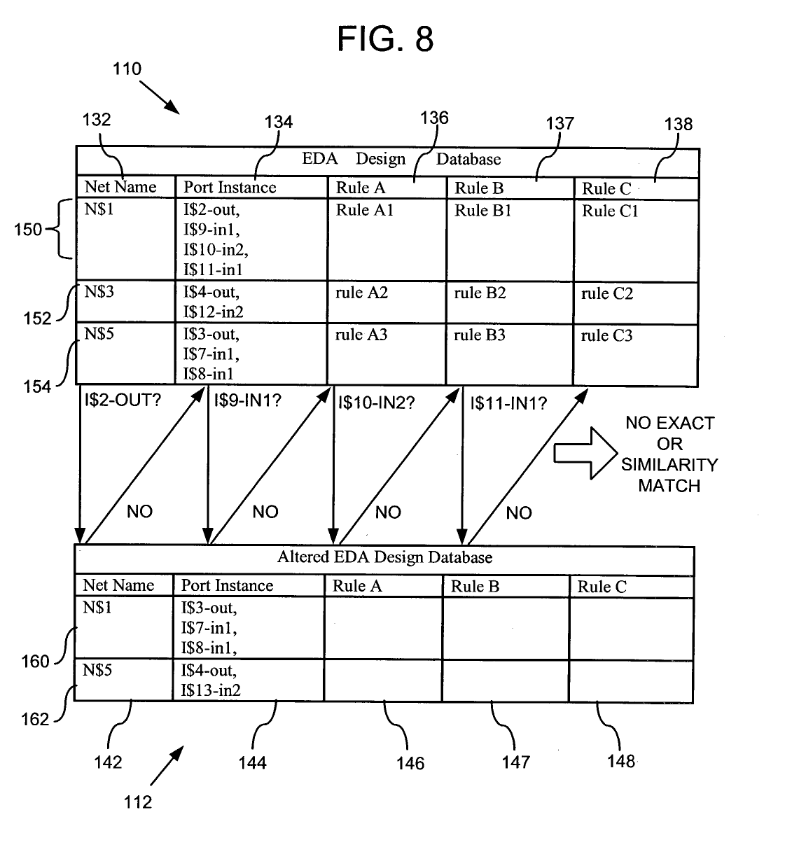

As illustrated in FIGS. 8-15, the database analyzer 120 may use the general method shown in FIG. 5A to import data from the EDA design database 110 to the revised EDA design database 112. FIGS. 8-15 illustrate one particular exemplary implementation of the general method of FIG. 5A. FIGS. 8-15 show an EDA design database 110 containing a number of entries defining electrical nets in an EDA design. Each entry further comprises a number of fields. For instance, a first entry 150 includes the net name in field 132, the associated list of port instances in field 134, and three rules fields 136, 137, 138 associated with the net. Although the EDA design database 110 in FIG. 8 contains entries defining electrical nets, it should not be construed as limiting in any way. As discussed above, the database may contain entries defining various other components, attributes, or rules.

The figures also show a revised version of the EDA design database 110. Revised EDA design database 112 includes fields 142, 144, 146, 147, 148 that correspond to fields 132, 134, 136, 137, 138 of the EDA design database 110. The rules fields 146, 147, 148 of the revised EDA design database 112, however, do not contain any rules data. Thus, an implementation of the general method shown in FIG. 5A is used to match entries from the EDA design database 110 with entries of the revised EDA design database 112 and to import the appropriate rules data. In the implementation illustrated in FIGS. 8-15, the entries of the EDA design database 110 are selected in process block 82 of FIG. 5A in the order in which they appear in the database, and each entry of the EDA design database 110 is matched with every entry of the revised EDA design database 112. Further, the following criteria are used for both the matching at process block 86 of FIG. 5A and the verifying at process block 88: (1) match the port instances using an exact matching method; (2) if no match is found, match the port instances using a similarity-based matching method; (3) if no match is found, match the net name using an exact matching method; and (4) if no match is found, do not match the entry. Further, for the importing at process block 90, rules data from the fields 136, 137, 138 of the selected entry in the EDA design database 110 is imported to the corresponding fields of the matching entry in the revised EDA design database 112.

In FIG. 8, the first entry 150 is considered (in FIGS. 8-15, the entry under consideration is shown in a bracket). First, the port instances from field 134 are compared with the port instances from field 144 of the revised EDA design database entries 160, 162. As shown by the arrows between the databases illustrating the process flow, the method determines that “I$2-out,” “I$9-in1,” “I$10-in2,” and “I$11-in1” are not present in an entry of the revised EDA design database. Moreover, because the port instances from entry 150 are not found anywhere in the revised EDA design, no similarity match is found.

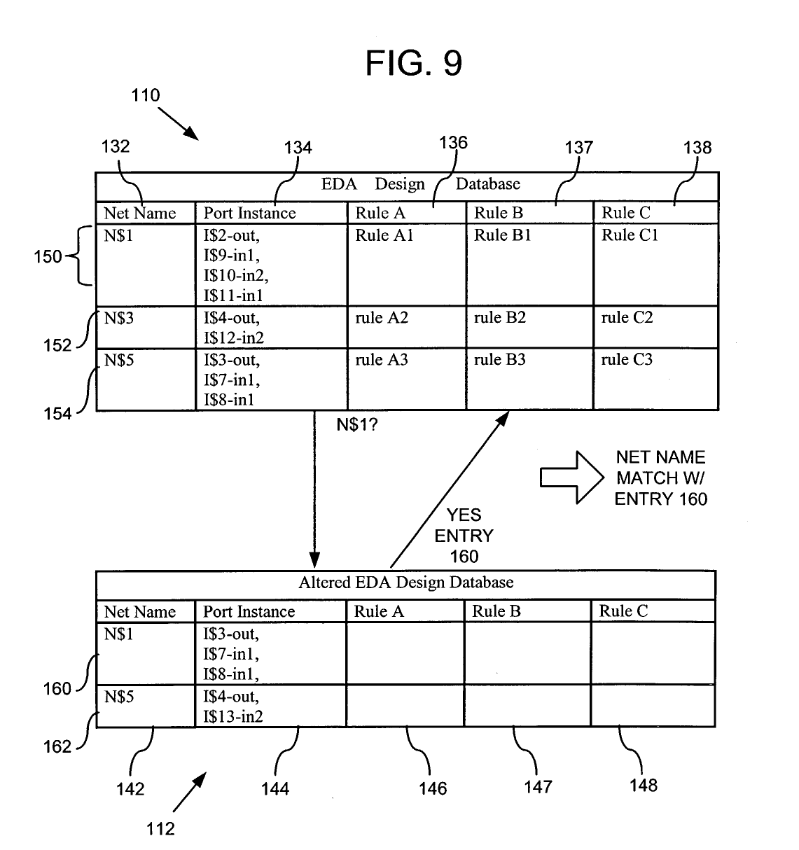

In FIG. 9, the net name of the first entry 150 is considered. As shown in FIG. 9, a net name match is found with entry 160 of the revised EDA design database 112. thus, entry 160 is a matching entry and the process proceeds to verify the match.

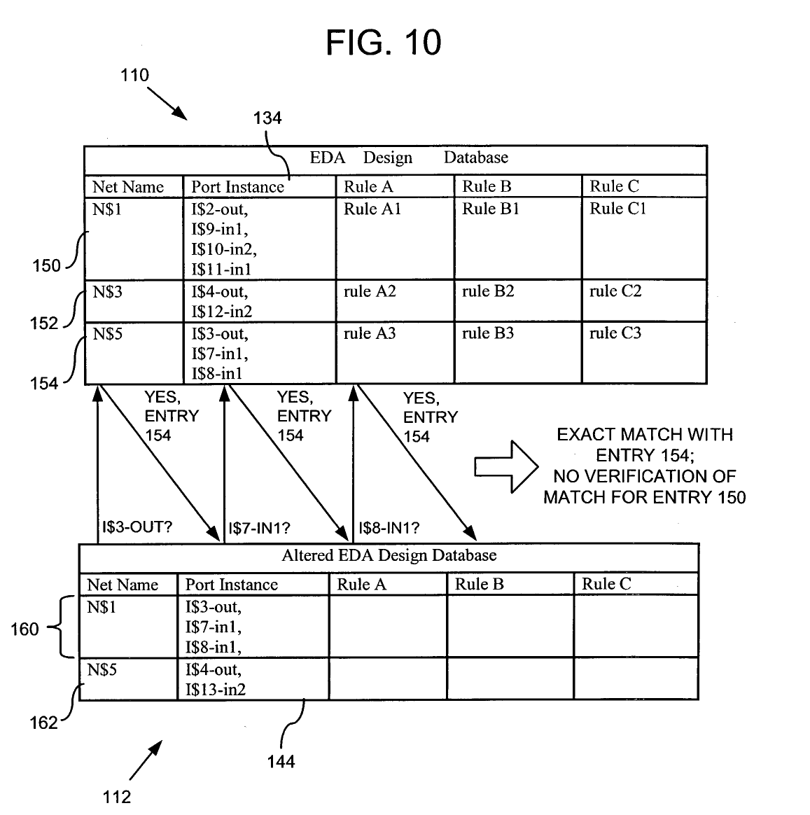

In FIG. 10, matching entry 160 of the revised EDA design database 112 is verified. In the illustrated implementation, the matching entry 160 is compared with all of the entries of the EDA design database 110. Using the same criteria as was used for the matching process, the port instances from field 144 of entry 160 of the revised EDA design database 112 are compared with field 134 of the entries of the EDA design database 110. The method determines that “I$3-out,” “I$7-in1,” and “I$8-in1” are all found in entry 154 of the EDA design database 110, not with the selected entry 150. Thus, the method determines that there exists an exact match with entry 154, not with the selected entry 150. Accordingly, because there exists a better match in the EDA design database, the match cannot be verified. The method reports that no match can be found for the selected entry 150 (e.g., in a separate database) and proceeds to the next entry of the EDA design database 110.

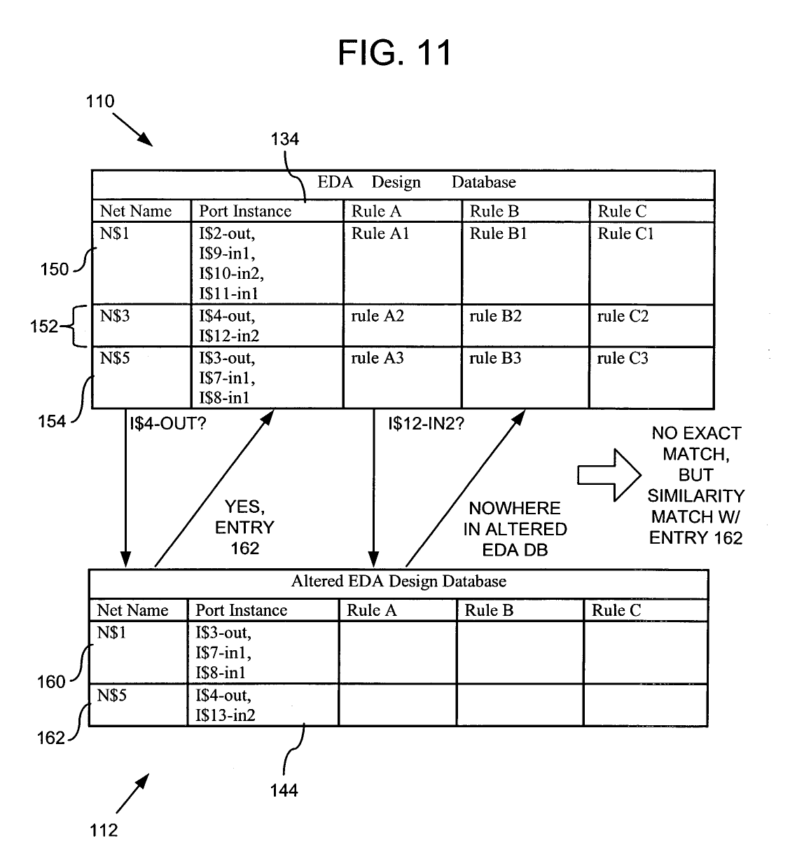

In FIG. 11, entry 152 of the EDA design database 110 is compared with the entries of the revised EDA design database 112. As seen in FIG. 11, the method compares field 134 of entry 152 of the EDA design database 110 with field 144 of the entries of the revised EDA design database 112. The method determines that “I$4-out” is found in entry 162, but that “I$12-in2” is not found in any entry of the revised EDA design database. Accordingly, the method determines that an exact match is not found, but that a similarity-based match is found.

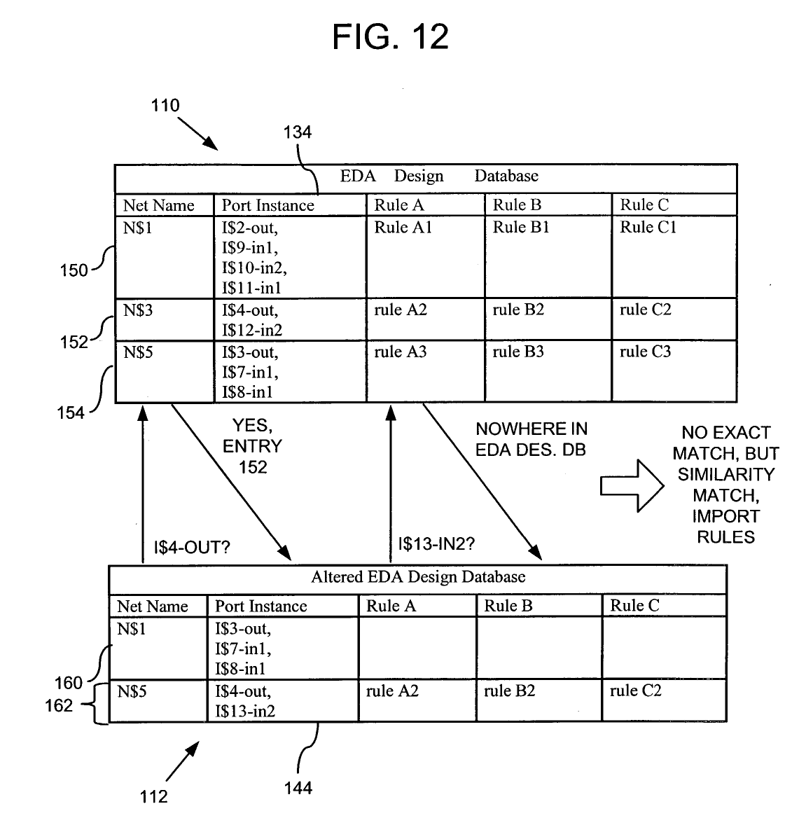

In FIG. 12, matching entry 162 is verified. Following the predetermined criteria, the method determines whether the port instances “I$4-out” and “I$13-in2” match exactly or similarly with the selected entry 152 by comparing the port instances in field 144 of entry 162 with each entry of the EDA design database 110. As seen in FIG. 12, the method determines that “I$4-out” is found in entry 152, but that “I$13-in2” is not found in any entry of the EDA design database 110. Accordingly, the method determines that an exact match is not found, but that a similarity-based match is found. Thus, the match is verified and the selected rules are imported from entry 152 of the EDA design database 110 to entry 162 of the revised EDA design database 112. The method then proceeds to the next entry of the EDA design database 110.

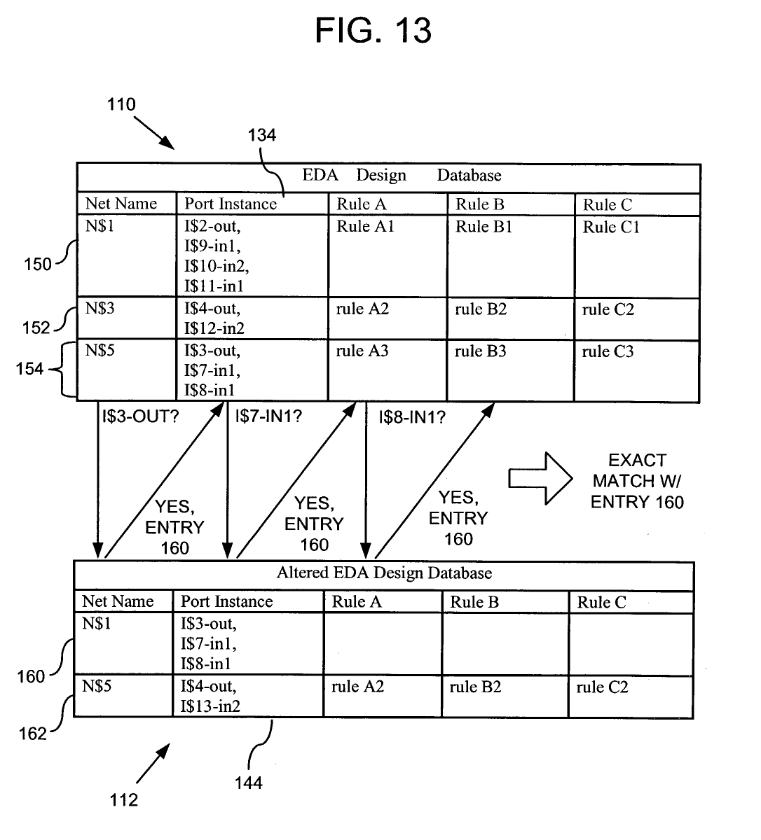

In FIG. 13, field 134 of entry 154 of the EDA design database 110 is compared with field 144 of the entries of the revised EDA design database 112. As seen in FIG. 13, the method determines that port instances “I$3-out,” “I$7-in1,” and “I$8-in1” are all found in the corresponding field of entry 160 of the revised EDA database 112. Accordingly, the method determines that there exists an exact match with entry 160 of the revised EDA design database 112.

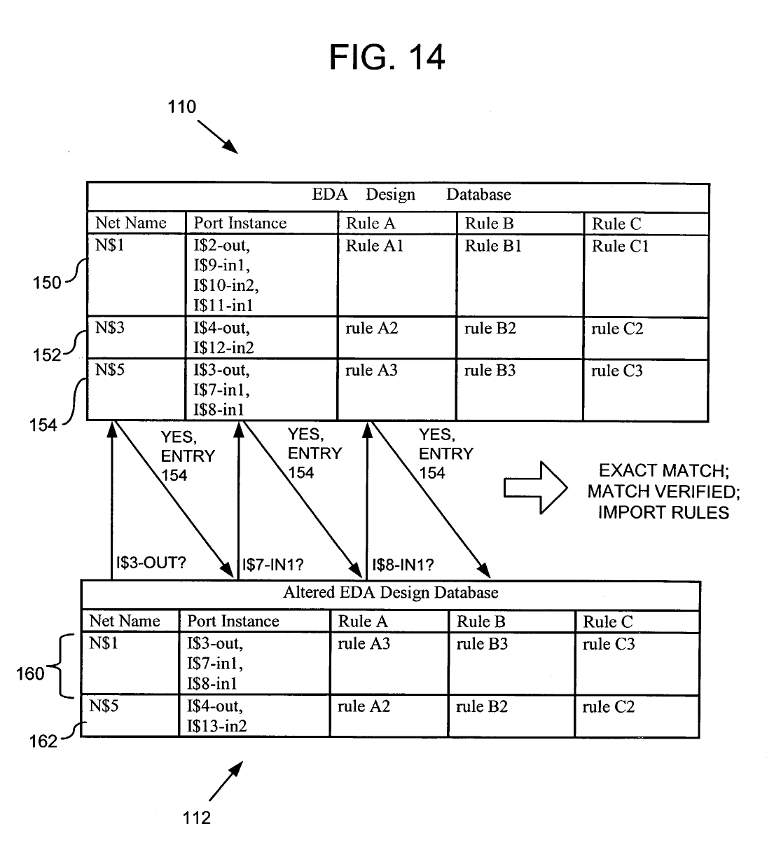

In FIG. 14, matching entry 160 is verified. Following the predetermined criteria, the method determines that port instances “I$3-out,” “I$7-in1,” and “I$8-in1” are found in entry 150 of the EDA design database 110. Accordingly, the verification process determines that an exact match is found and verifies the match. As shown in FIG. 14, the rules from entry 154 are imported to the matching entry 162.

The above example is for illustrative purposes only and should not be construed as limiting in any way. The method may be modified in a number of ways depending on the particular application. For instance, the criteria may be adjusted so that the net name is matched first using an exact matching method.

Third Representative Embodiment

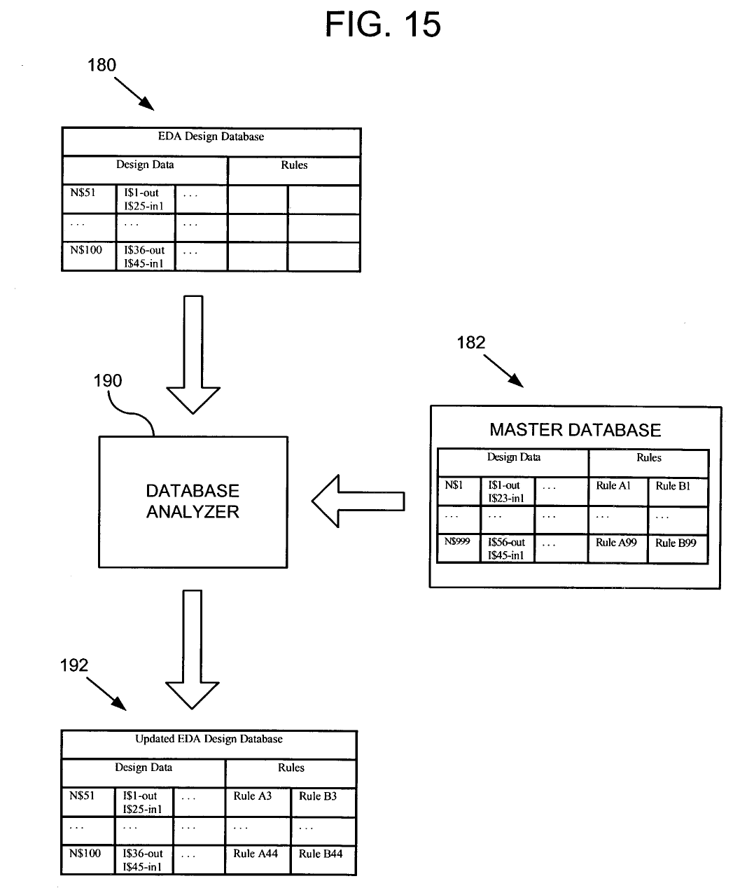

FIG. 15 is a block diagram illustrating the operation of a third representative embodiment. In general, the third representative embodiment involves importing attributes and/or rules from a master database 182 to an EDA design database 180. The master database 182 of this embodiment may contain a variety of information. For instance, the master database 182 may contain known rules and/or attributes (e.g., rules and attributes from earlier EDA designs made by a particular designer or organization). The master database may be continually updated to include rules and/or attributes from newer designs. As shown in FIG. 15, a database analyzer 190 matches entries of the EDA design database 180 with entries of the master database 182 and determines whether and what rules should be imported. After analysis, the database analyzer 190 imports the selected rules from the master database 182 to the EDA design database 180 and outputs an updated EDA design database 192. In one implementation of this embodiment, entries of the EDA design database that are unable to be matched with entries of the master database are output to the designer in a separate output database. As a result of the data analyzer, a designer need not enter all of the attributes and/or rules that are used during simulation, but can instead reuse rules entered previously for identical or highly similar EDA designs. In this way, the sharing of information among common designs is maximized. The process of importing rules from the master database 182 may be performed in real-time and continuously updated during the design process or at predetermined time intervals (e.g., every 30 minutes, after a design is finished). In one particular implementation of this embodiment, multiple designers are allowed to work simultaneously on a single EDA design, which is continuously updated. Thus, for instance, three designers may work on three different areas of a single EDA design at the same time.

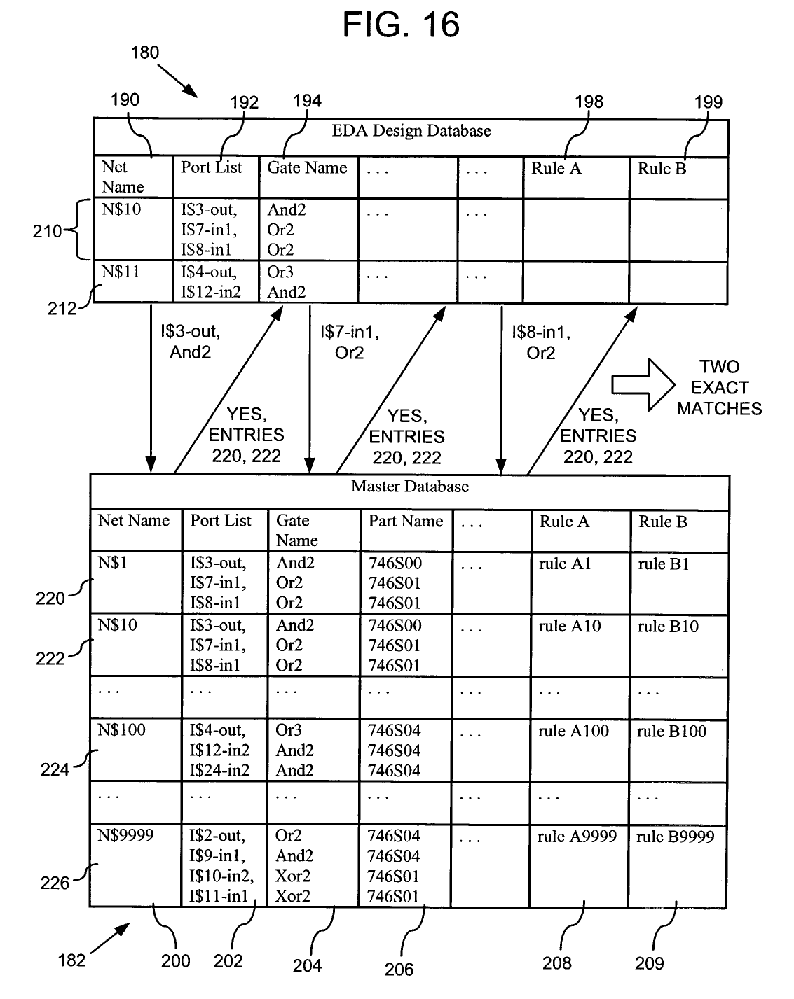

FIGS. 16-20 show a particular exemplary implementation of the third embodiment using the general method of FIG. 5B. FIGS. 16-20 show an EDA design database 180 that contains a number of entries 210, 212 defining electrical nets in an EDA design. Each entry contains a number of fields. For instance, in FIG. 16, each entry of the original EDA design database 180 contains a net name in the first field 190, an associated portlist in field 192, the gate name associated with the port instance in field 194, and additional data (indicated by the ellipses). Each entry of the EDA design database 180 also contains two rules fields 198, 199 that do not contain any data. Although the EDA design database 180 shown in FIG. 16 contains entries defining electrical nets, the database should not be construed as limiting in any way. The database may instead contain entries defining various other components, attributes, or rules.

FIGS. 16-20 also show a master database 182 with fields 200, 202, 204, 208, 209 corresponding to the fields 190, 192, 194, 198, 199 of the original design database 180. The master database 182 includes an additional field 206 containing the part name associated with each port in the portlist of field 202. The illustrated implementation of the general method matches entries from the EDA design database 180 with entries from the master database 182 and imports the appropriate rules from the master database 182 to the EDA design database 180. In the illustrated implementation, the entries of the EDA design database 180 are selected in process block 82 of FIG. 5B in the order in which they appear in the database, and each entry of the EDA design database 180 is matched with every entry of the master design database 112. Further, the following criteria are used for the matching at process block 86 of FIG. 5B: (1) match port instances and gate names using an exact matching method; (2) if no match is found, match the port instances and gate names using a similarity-based matching method; and (3) if no match is found, do not match the entry. Because this embodiment involves the use of a master database 182 containing multiple EDA designs, it is possible that the matching at process block 86 of FIG. 5B will return multiple matching entries from the master database. In these instances, an additional criteria may be used to determine whether one of the matching entries is a better match. In the illustrated implementation, if criteria (1) or (2) indicate that multiple entries of the master database 182 match the selected entry of the original EDA design database 180, then the net name of the multiple matching entries is matched and verified using an exact matching method.

As shown in process block 89 of FIG. 5B, the verifying further determines whether there exists a disqualifying criteria for the match. In the illustrated embodiment, the method determines whether the part names from the matching entry of the master database are acceptable part types (e.g., whether the part types are available). This verification is performed by determining whether the part names from the matching entry appear in a secondary database (not shown) listing all available parts.

For the importing at process block 90 of FIG. 5B, data from selected fields of the master database 182 is imported to corresponding fields of the EDA design database 180. In the illustrated implementation shown in FIGS. 16-20, the fields that are imported depend on the criteria used to match the entries. In particular, if criteria (1) is satisfied in both matching and verification processes, rules A and B are imported from fields 208, 209, but if just criteria (2) is satisfied, only rule A is imported from field 208.

In FIG. 16, the first entry 210 is considered (in FIGS. 16-20, the entry under consideration is shown in a bracket). The port instances from field 192 and the gate names from field 194 are compared with the corresponding fields 202, 204 of the master database. Thus, as shown by the arrows between the databases illustrating the process flow, the method determines that two entries of the master database (entries 220, 222) match fields 192, 194 of the first entry 210 of the EDA design database. Because all port instances and gate names are found in entries 220, 222, an exact match is found.

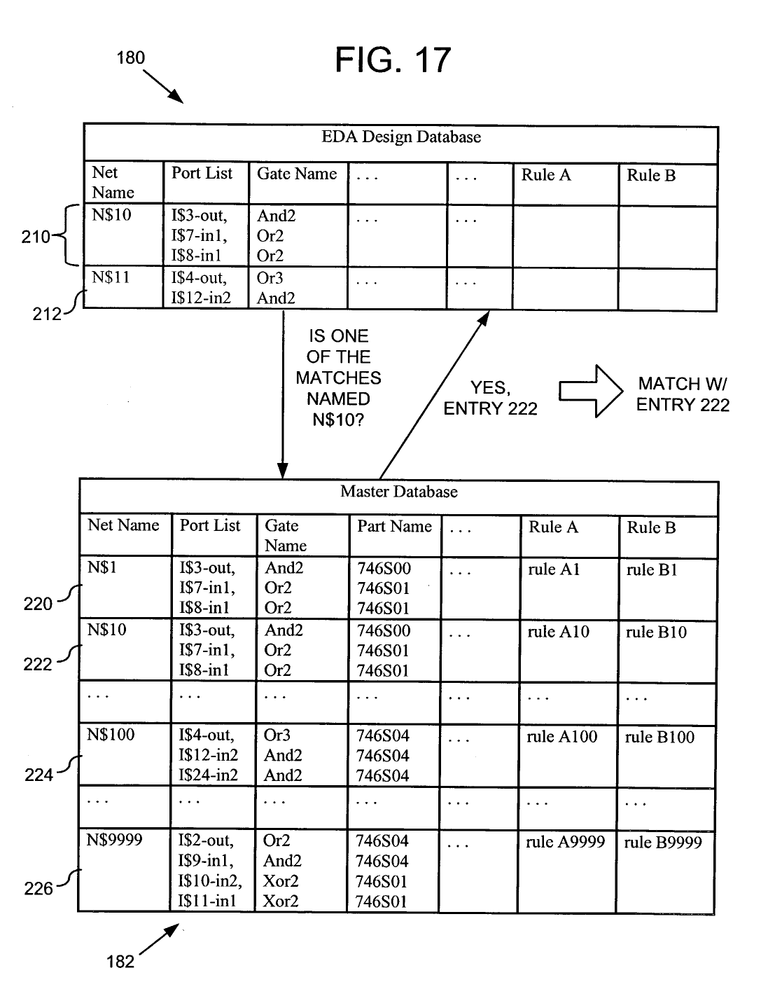

In FIG. 17, the additional criteria are considered to select the best possible match between the two candidate entries. As shown in FIG. 17, entry 222 has a net name that exactly matches the selected entry 210. Thus, a match is made and the method proceeds to verifying the match. In this way, the additional criteria is used to include or disqualify entries from the original match.

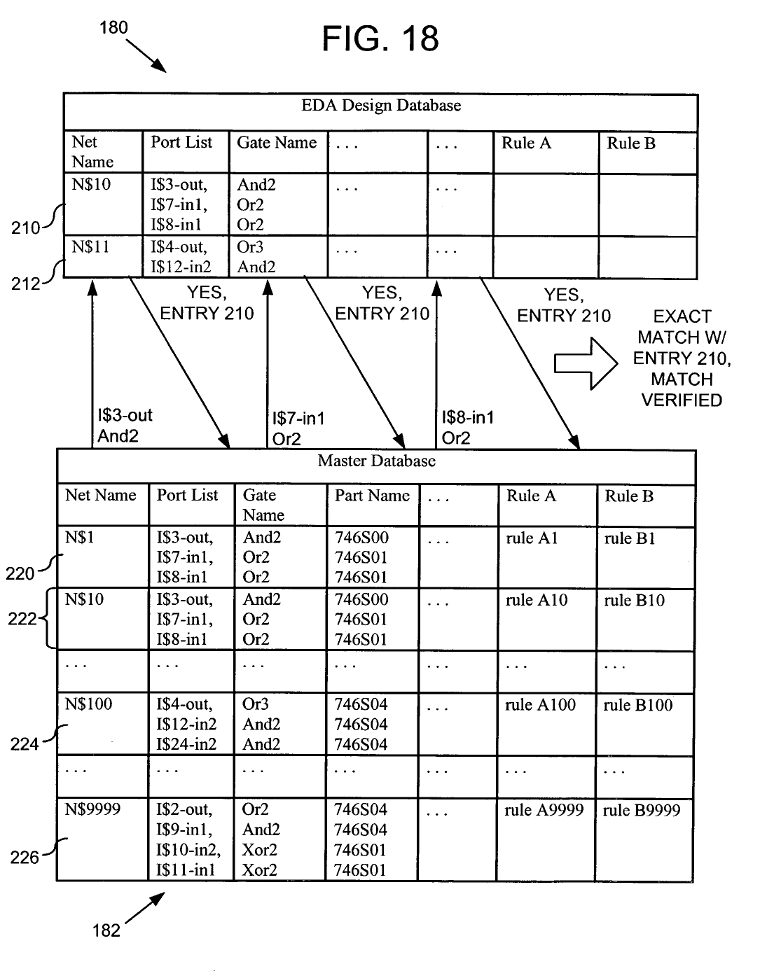

In FIG. 18, matching entry 222 is verified. In the illustrated implementation, the matching entry 222 is compared with all of the entries of the EDA design database 180. Following the predetermined criteria, the port instances and gate names of the matching entry 222 are compared with the entries of the EDA design database 180. As seen in FIG. 18, the method determines that entry 210 exactly matches the matching entry 222.

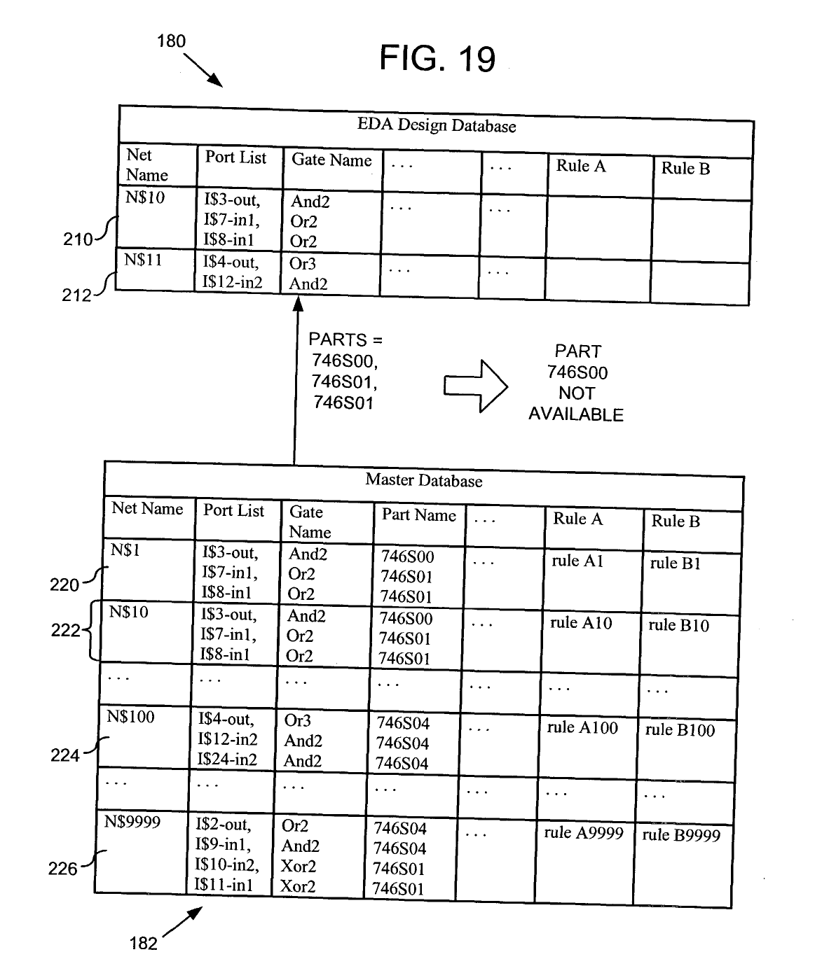

In FIG. 19, any disqualifying criteria are considered. In the illustrated implementation, the part name field 206 of matching entry 222 is compared with a field of a secondary database (not shown) containing a list of all the available parts. As shown in FIG. 19, one of the parts used in the matching entry 222 (746S00) is no longer available and the verification fails. Accordingly, the matching entry 222 is rejected and no rules are imported.

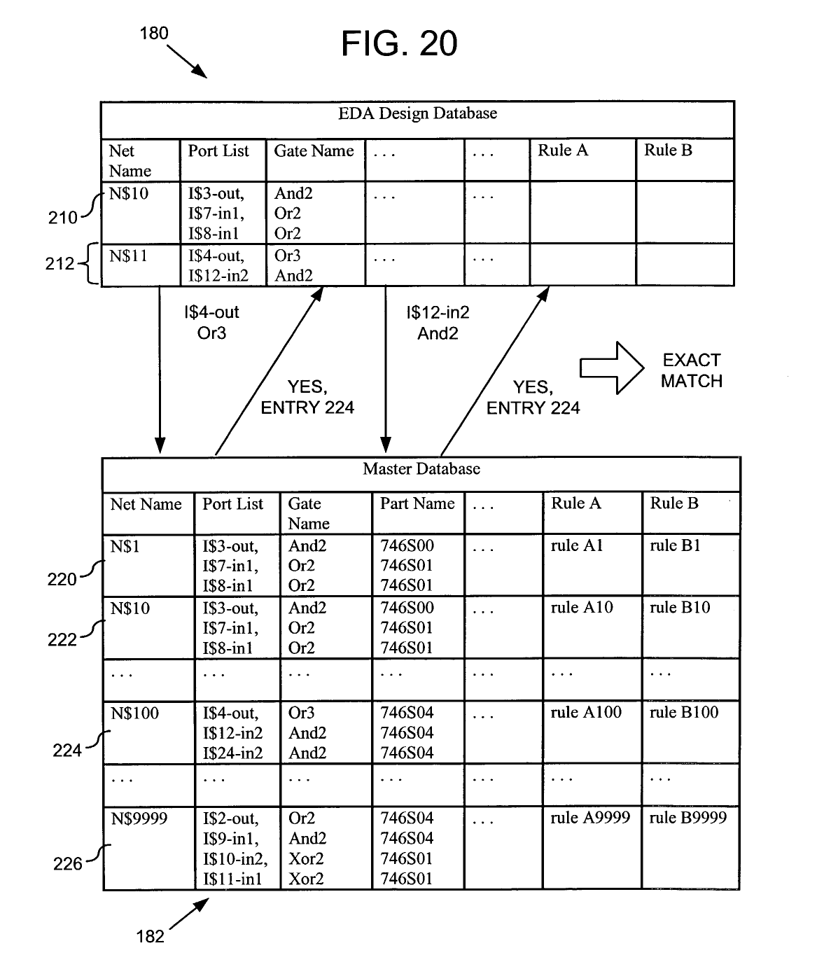

In FIG. 20, entry 212 of the EDA design database 180 is considered. The port instances and the gate names are compared with the corresponding fields of the master database 182. As shown by the arrows in FIG. 19, all port instances and gate names of entry 212 are found in entry 224 of the master database 182.

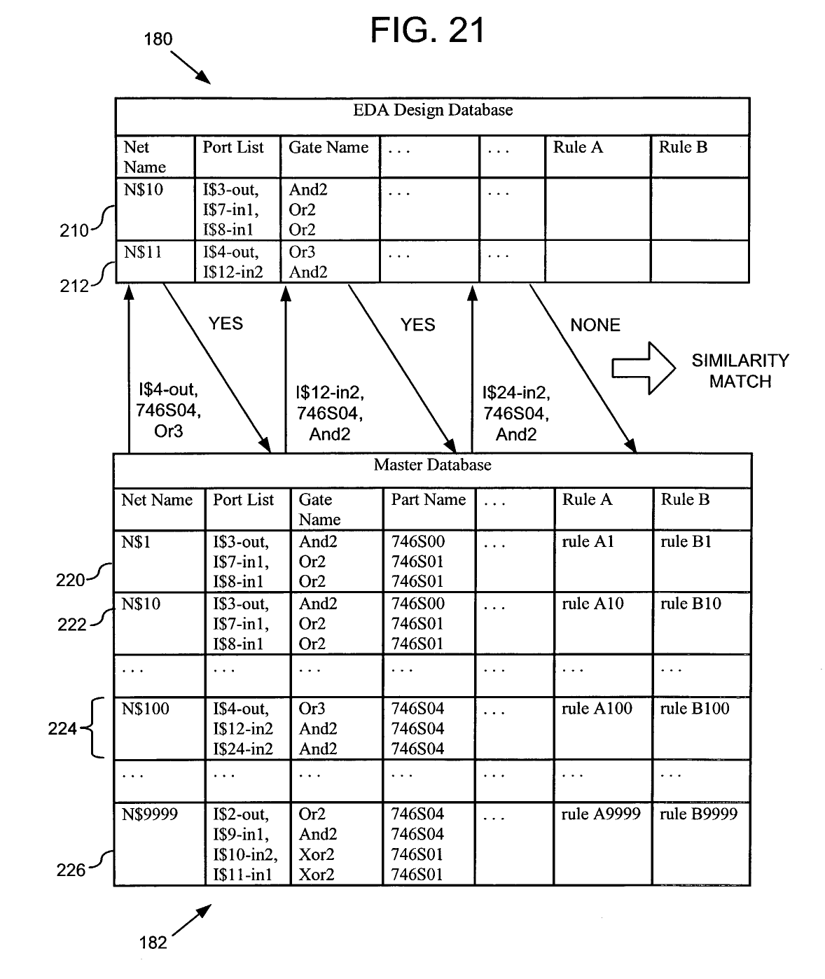

In FIG. 21, matching entry 224 is verified. Here, two of the three port instances, part names, and gate names are found in the selected entry 212 of the EDA design database 180. The third port instance, “I$24-in2,” however, is not found anywhere in the EDA design database 180. Accordingly, a similarity-based match is found between the selected entry 212 and the matching entry 224, and only rule A100 can be imported.

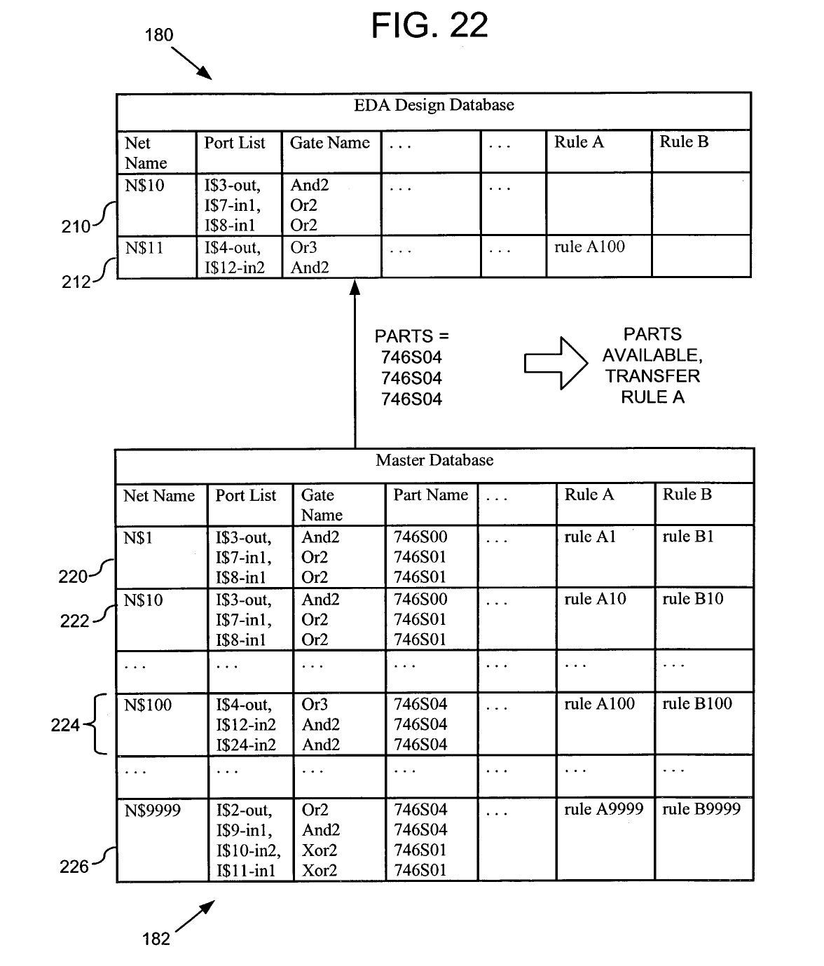

In FIG. 22, any disqualifying criteria are considered. In the illustrated implementation, the part name field 206 of matching entry 224 is compared with a field of a secondary database (not shown) containing a list of all the available parts. As shown in FIG. 19, the parts used in the matching entry 224 are all available and the verification process is satisfied. Accordingly, rule A100 is imported from the master database 182 to the EDA design database 180.

The above example is for illustrative purposes only and should not be construed as limiting in any way. The method may be modified in a number of ways depending on the particular application.

Use of a Client-Server Network

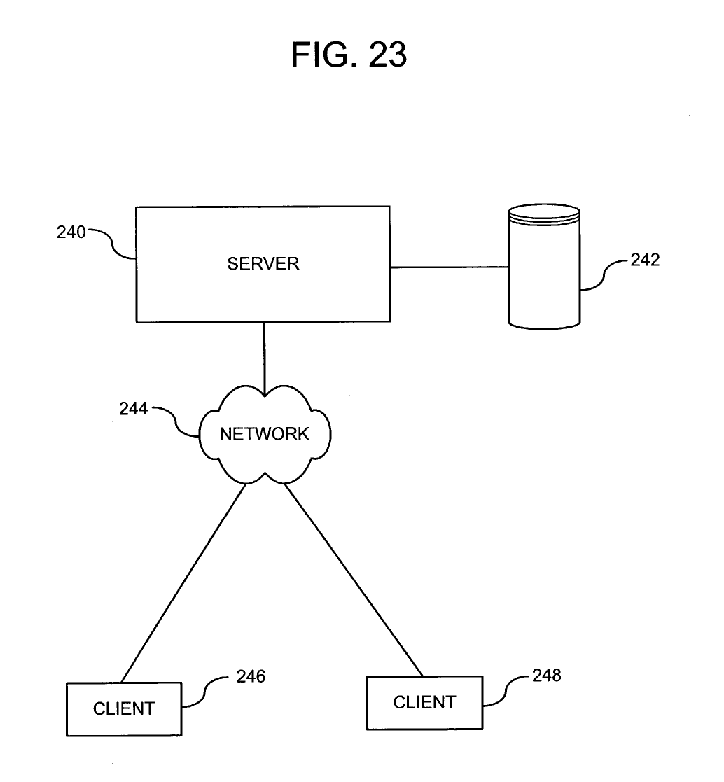

Any of the aspects of the technology described above may be performed in a distributed computer network. FIG. 23 shows an exemplary network. A server computer 240 may have an associated storage device 242 (internal or external to the server computer). The server computer 240 may be configured to perform any of the implementations described above. The server computer 240 may be coupled to a network, shown generally at 244. One or more client computers, such as those shown at 246, 248, may be coupled to the network 244 and interface with the server computer 240 using a network protocol.

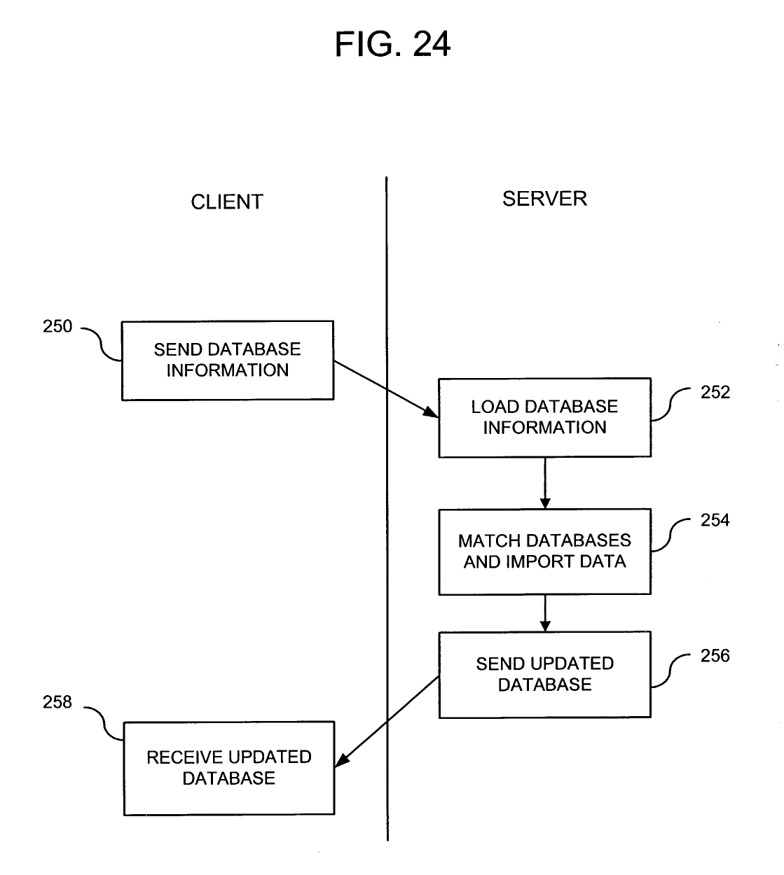

FIG. 24 shows that a database may be matched with another database and that rules and/or attributes may be transferred between the databases according to the disclosed methods using a remote server computer, such as a server computer 240 in FIG. 23. In process block 250, the client computer sends data relating to the databases to be matched. For instance, the client computer may send an EDA design database and a different version of the EDA design database. Alternatively, the client computer may send an EDA design database to be matched with a master database, which may also be sent or which may be stored separately on the server computer or sent from a separate location. In process block 252, the data is received and loaded by the server computer. In process block 254, the databases are matched according to any of the embodiments described above and a new updated database is created. In process block 256, the server computer sends the updated database to the client computer, which receives the database in process block 258. It should be apparent to those skilled in the art that the example shown in FIG. 24 is not the only way to match one database with another between a client and a server. For instance, the data relating to the databases may be stored in a computer-readable media that is not on a network and sent separately to the server. Or, the server computer may perform only a portion of the procedures described above.

Having illustrated and described the principles of the illustrated embodiments, it will be apparent to those skilled in the art that the embodiments can be modified in arrangement and detail without departing from such principles. In view of the many possible embodiments, it will be recognized that the illustrated embodiments include only examples and should not be taken as a limitation on the scope of the invention. Rather, the invention is directed to new and unobvious features and method acts disclosed herein, both individually and in subcombinations and combinations thereof as defined by the following claims. The methods and apparatus are not limited to technology which overcomes all or any specific disadvantages of known technology or to any specific combination(s) of features or method acts. We therefore claim as the invention all such embodiments that come within the scope of these claims.

What is claimed is:

1. A method of matching database entries in an electronic design automation (EDA) environment, comprising:
comparing a selected entry of a first database to multiple entries of a second database;
matching the selected entry of the first database to one of the multiple entries of the second database; and
verifying the matching by comparing the matching entry of the second database with multiple entries of the first database.

2. The method of claim 1, wherein the verifying includes determining whether the matching entry of the second database matches with the selected entry of the first database.

3. The method of claim 1, wherein the verifying is performed before comparing and matching a next entry.

4. The method of claim 1, wherein the matching includes determining whether data in one or more fields of the selected entry in the first database is identical to data in the one or more corresponding fields of the matching entry in the second database, and wherein the one or more fields are non-primary-key fields.

5. The method of claim 1, wherein the verifying includes determining whether data in one or more fields of the matching entry in the second database is identical to data in the one or more corresponding fields of the selected entry in the first database, and wherein the one or more fields are non-primary-key fields.

6. The method of claim 1, wherein the matching includes determining whether a portion of data from a field of the selected entry of the first database is present in the corresponding field of the matching entry of the second database and whether a remainder of data from the field of the selected entry is not present in the corresponding field of any entry of the second database.

7. The method of claim 1, wherein the verifying includes determining whether a portion of data from a field of the matching entry of the second database is present in the corresponding field of the selected entry of the first database and whether a remainder of data from the field of the matching entry is not present in the corresponding field of any entry of the first database.

8. The method of claim 1, further comprising importing data from selected fields of the selected entry of the first database to corresponding selected fields of the matching entry of the second database.

9. The method of claim 8, wherein the selected fields contain data concerning attributes or rules of an EDA design, and wherein the first database is an EDA design database and the second database is an altered version of the EDA design database.

10. The method of claim 1, wherein the verifying includes determining whether the matching entry of the second database has a disqualifying criteria.

11. The method of claim 1, further comprising importing data from selected fields of the matching entry of the second database to corresponding selected fields of the selected entry of the first database.

12. The method of claim 11, wherein the selected fields contain data concerning attributes or rules of an EDA design, and wherein the first database is an EDA design database and the second database is a master database of known rules or attributes.

13. The method of claim 12, wherein the selected entry is one of multiple entries of the master database that matches with the selected entry.

14. The method of claim 1, wherein comparing the selected entry, matching the selected entry, and verifying the matching is performed by a combination of at least one client and at least one server.

15. The method of claim 14, further comprising transferring an electronic file containing data related to the first database from the at least one client to the at least one server.

16. The method of claim 14, further comprising transferring an electronic file corresponding to an updated database from the at least one server to the at least one client.

17. A client computer displaying or using a database compiled by a server computer according to the method of claim 1, the client and server computers communicating via a network.

18. A computer-readable medium storing computer-executable instructions for causing a computer system to perform the method of claim 1.

19. A method of matching database entries in an electronic design automation (EDA) environment, comprising:
matching a selected entry of a first database with a matching entry of a second database if data in one or more fields of the selected entry is identical to data in corresponding fields of the matching entry, the one or more fields being non-primary-key fields.

20. The method of claim 19, further comprising verifying the matching by comparing the matching entry of the second database with multiple entries of the first database and determining whether the matching entry of the second database matches the selected entry according to a predetermined criteria.

21. A method of matching database entries in an electronic design automation (EDA) environment, comprising:
matching a selected entry of a first database with a matching entry of a second database if a field of the selected entry has a portion of data present in the corresponding field of the matching entry and a remaining portion not present in the corresponding field of any entry of the second database.

22. The method of claim 21, further comprising verifying the matching by comparing the matching entry of the second database with multiple entries of the first database and determining whether the matching entry of the second database matches the selected entry according to a predetermined criteria.

23. The method of claim 22, wherein the predetermined criteria includes determining if data in one or more fields of the matching entry of the second database is identical to data in corresponding fields of the selected entry of the first database, the one or more fields being non-primary-key fields.

24. The method of claim 22, wherein the predetermined criteria includes determining if a field in the matching entry of the second database has a portion of data present in the corresponding field of the selected entry of the first database and a remaining portion of data not present in the corresponding field of any entry of the first database.

25. The method of claim 21, wherein the first database is an EDA design database and the second database is an altered version of the EDA design database, the method further comprising importing attribute or rules from the selected entry to the matching entry.

26. The method of claim 21, wherein the first database is an EDA design database and the second database is a master database of known rules or attributes, the method further comprising importing attribute data or rules from the matching entry to the selected entry.

27. A method of transferring data between a first database and a second database in an electronic design automation (EDA) environment, comprising:
comparing a first database entry to multiple second database entries;
matching the first database entry to a matching second database entry by:
(a) determining whether data in a first field of the first database entry satisfies a first criteria when compared to a corresponding first field of multiple second database entries; and
(b) if the data does not satisfy the first criteria, determining whether data in a second field of the first database entry satisfies a second criteria when compared to a corresponding second field of multiple second database entries; and
importing a first set of data when the first criteria is satisfied and a second set of data when the second criteria is satisfied.

28. The method of claim 27, further comprising verifying the matching if the second criteria is satisfied by determining whether data in the corresponding first field and second field of the second database entry satisfy the first criteria and the second criteria when compared to data in the first field and second field of multiple first database entries.

29. The method of claim 27, wherein the first field and the second field are non-primary key fields, and wherein:
the first criteria includes determining if data in the first field of the first database entry is identical to data in the corresponding first field of the second database entry; and
the second criteria includes determining if the second field of the first database entry has a portion of data present in the corresponding second field of the second database entry and a remaining portion not present in the corresponding second field of any entry of the second database.

30. The method of claim 27, wherein the first field and the second field are the same field.

31. The method of claim 27, wherein the first database is an EDA design database, and the second database is an altered version of the EDA design database.

32. The method of claim 27, wherein the first database is an EDA design database, and the second database is a master database of known attributes and/or rules.

33. A method of analyzing databases in an electronic design automation (EDA) environment, comprising:
individually matching an entry of an EDA design database to multiple entries of a master database containing known attributes and/or rules.

34. The method of claim 33, wherein the matching is performed once per entry of the original design database.

35. The method of claim 33, further comprising transferring attributes and/or rules from the master database to the entries of the EDA design database.

36. The method of claim 33, wherein the matching is performed in real time during a design process.

37. The method of claim 33, wherein the matching comprises:
comparing data in one or more selected fields of a selected entry of the EDA design database with data in corresponding fields of the entries of the master database;
determining whether an entry of the master database matches the selected entry according to a first predetermined criteria; and
if an entry of the master database matches the selected entry, verifying the match by determining whether the matching entry of the master database has a disqualifying criteria when compared to the selected entry.

38. The method of claim 37, wherein the predetermined criteria includes matching additional fields of the selected entry to corresponding additional fields of the entries of the master database if more than one entry of the master database matches the selected entry.

39. An electronic design automation (EDA) tool for matching databases, comprising a computer programmed to compare a selected entry of a first database to multiple entries of a second database, to match the selected entry of the first database to one of the multiple entries of the second database, and to verify the match by comparing the matching entry of the second database with multiple entries of the first database.

40. An electronic design automation (EDA) tool for matching databases, comprising a computer programmed to individually match an entry of an EDA design database to multiple entries of a master database containing known attributes and/or rules.

41. An electronic design automation (EDA) tool for matching databases, comprising:
means for selecting an entry from a first database; and
means for matching the selected entry from the first database with a matching entry of a second database if a field of the selected entry has a portion of data present in the corresponding field of the matching entry and a remaining portion not present in the corresponding field of any entry of the second database.
